(19) United States
(12) Patent Application Publication
(10) Pub. No.: US 2011/0102652 A1
(43) Pub. Date: May 5, 2011

(54) Image Detecting Module and Lens Module

(76) Inventors: Chien-Hsin LU, Wugu Township (TW); Zheng-Yu WU, Wugu Township (TW)

(21) Appl. No.: 12/704,917

(22) Filed: Feb. 12, 2010

(30) Foreign Application Priority Data
Oct. 30, 2009 (TW) 098136821

(51) Int. Cl. H04N 5/335

(52) U.S. Cl. 348/294; 348/E05.091

(57) ABSTRACT

An image detecting module includes a socket, a circuit board, an image sensor, an elastic element, a filter and a holder. The socket comprises an inner circumference wall along a main axis for defining an inner space and a platform that extended from the inner circumference wall. Pluralities of mounting holes are provided on the holder and pluralities of protrusions are provided on the socket; thus the elastic element and the filter could be fixed between the platform and the holder by fitting the protrusions into the mounting holes.

### BACKGROUND OF THE INVENTION

1. Field of the Invention

The present invention relates to a lens module, and more particularly, to a lens module of digital camera formed with components such as the filter being fixed on a stand-alone socket using the holder.

2. Description of the Prior Art

Currently on the market, mobile phones (or cell phones) with photo-taking function, digital cameras, and video cameras are all deployed with a lens module. A lens module consists essentially of a lens group, a lens barrel, and an image sensor. FIG. 1 is a views of lens module of the conventional prior art. The lens module consists of the lens group 81, lens barrel 82, and image sensor 83. The lens group 81 are placed inside the lens barrel 82 and include a lens 811 used for focalization and a filter 812 for eliminating specific optical frequency. The image sensor 83 is equipped on one side of the lens barrel 82 and includes one transparent cover plate 831, an image sensing chip 832, and one base board 833.

As shown in FIG. 1, the image sensing chip 832 is fixed on the base board 833 and further packaged between the transparent cover plate 831 and the base board 833 by using the transparent cover plate 831. Thus, the optical image signal entering the lens barrel 82 is firstly focalized through the lenses 811, is filtered by the filter 812, and then passes through the transparent cover plate 831 to the image sensing chip 832. The image sensing chip 832 further converts the optical image signal to the electronic image signal.

For the lens module described above, since an area 821 is to be provided by the lens barrel 82 for placing the filter 812 and both the lens barrel 82 and the filter 812 are made of plastic, it is easier for the assembly to occupy more space and become heavier. Hence, if the filter placement area 821 can be saved, the lens module can thus become thinner.

Referring to FIG. 2, which is a view of another lens module of the prior art. The lens module comprises a socket 91, a lens unit 92 screwed into the socket 91, an elastic element 93 inserted in the socket 91, a filter 94 fixed inside the socket 91, an image sensing chip 95, and a circuit board 96. This method of assembly allows the lens module to become thinner, but the filter 94 needs to be dispensed to be fixed on the socket 91 and thus the assembling process will be non-reversible. In the actual production process, the assembly may be re-processed because of the tilted optical axis. In the re-assembling process, the filter 94 dispensed and fixed on the socket 91 will be damaged and the cost is thus increased.

### SUMMARY OF THE INVENTION

In view of the above, one object of the present invention is to provide a lens module in which the filter is placed on a stand-alone socket to avoid the deployment of filter placement area inside the lens barrel, wherein the thickness is effectively reduced and the lens module becomes thinner.

Another object of the present invention is to provide a lens module in which a holder is utilized to fix the filter on the stand-alone socket. The holder allows the lens module to be reassembled, facilitates the assembling process, and raises the yield of assembly.

Still another object of the present invention is to provide a lens module in which a holder is used to fix the filter on the stand-alone socket. When the lens module is de-assembled, damages to the filter and the socket can be prevented by using such method and the production cost can thus be effectively reduced.

According to the above objects, the present invention provides an image sensing module, which includes a socket, a circuit board, an image sensor, an elastic element, a filter, and a holder. The socket comprises a circumference wall that is formed around an axis and defines an accommodating space and a supporting platform that extends from the circumference wall to the accommodating space. The socket is disposed with a plurality of fastening protrusions and the holder has a plurality of holes for being engaged by the plurality of fastening protrusions, and thus the aforementioned elastic element and the filter are fixed on the supporting platform of the socket.

Moreover, the present invention provides a lens module which includes a lens group, a lens barrel, and an image sensing module. The lens group is disposed inside the lens barrel and an image sensing module is disposed on one side of the lens barrel. The image sensing module includes a socket, a circuit board, an image sensor, an elastic element, a filter, and a holder. The socket comprises a circumference wall that is formed around an axis and defines an accommodating space and a supporting platform that extends from the circumference wall to the accommodating space. The socket is disposed with a plurality of fastening protrusions and the holder has a plurality of holes for being engaged by the plurality of fastening protrusions. Thus the aforementioned elastic element and the filter are fixed on the supporting platform of the socket.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a cross-sectional view of a lens module of the prior art;

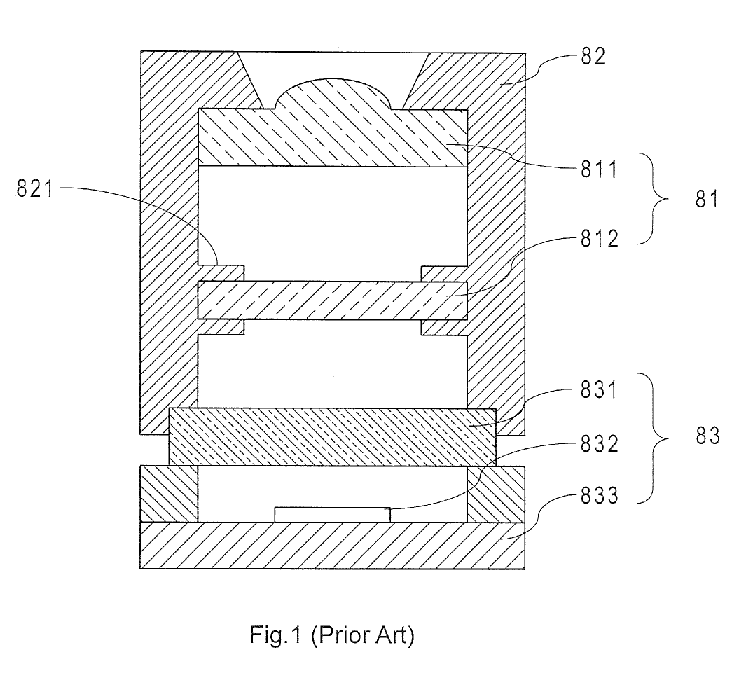

FIG. 2 is a cross-sectional view of another lens module of the prior art;

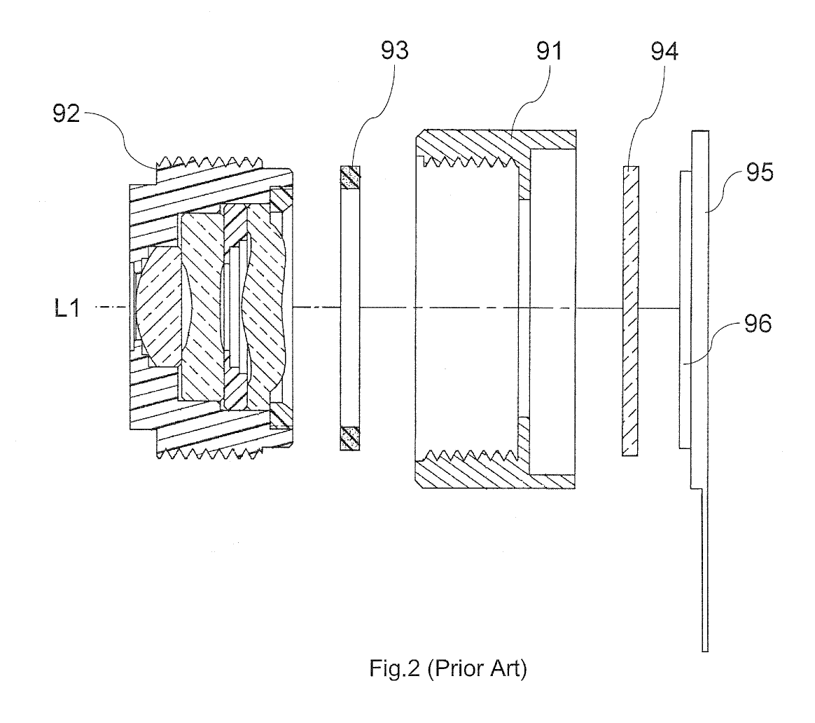

FIG. 3 is a cross-sectional view of a lens module of the present invention;

FIG. 4 is an exploded view of the first embodiment of the image sensing module of the lens module of the present invention;

FIG. 5 is a view of the socket of the image sensing module of the first embodiment;

FIG. 6 is a view of the holder of the image sensing module of the first embodiment;

FIG. 7 is a view of the completed assembly of the image sensing module of the first embodiment;

FIG. 8 is an exploded view of the second embodiment of the image sensing module of the lens module of the present invention;

FIG. 9 is a view of the socket of the image sensing module of the second embodiment;

FIG. 10 is a view of the holder of the image sensing module of the second embodiment;

FIG. 11 is a view of the completed assembly of the image sensing module of the second embodiment;

FIG. 12 is an exploded view of the third embodiment of the image sensing module of the lens module of the present invention;

FIG. 13 is a view of the socket of the image sensing module of the third embodiment;

FIG. 14 is a view of the holder of the image sensing module of the third embodiment; and

FIG. 15 is a view of the completed assembly of the image sensing module of the third embodiment.

### DESCRIPTION OF THE PREFERRED EMBODIMENT

For a comprehensive and clear disclosure of technical contents, the purpose of invention, and the achieved effects, the detailed description taken in conjunction with the drawings and drawing No. is shown below.

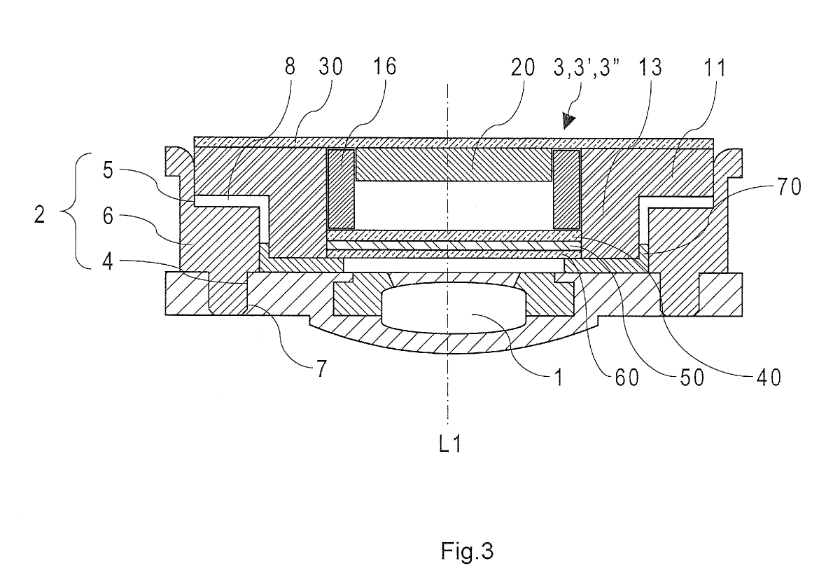

First, referring to FIG. 3, a lens module of the present invention includes a lens group 1, a lens barrel 2, and an image sensing module 3, 3′, 3″. The lens barrel comprises a first circumference wall 4 formed around an axis L1, a second circumference wall 5 formed around the same axis L1 as the first circumference wall 4, and a shoulder 6 connecting the first circumference wall 4 to the second circumference wall 5. The above-mentioned first circumference wall 4 encloses the first accommodating space 7 for containing the lens group 1, and the second circumference wall 5 encloses the second accommodating space 8 larger than the first vacant space 7 for containing the image sensing module 3, 3′, 3″. Wherein the image sensing module 3, 3′, 3″ is fixed to the shoulder 6 between the first circumference wall 4 and second circumference wall 5 by lock-fasteners such as screws. Besides, the image sensing module 3, 3′, 3″ are different embodiments of the present invention and the difference lies in the structure of the holder. This will be described in detail in the following.

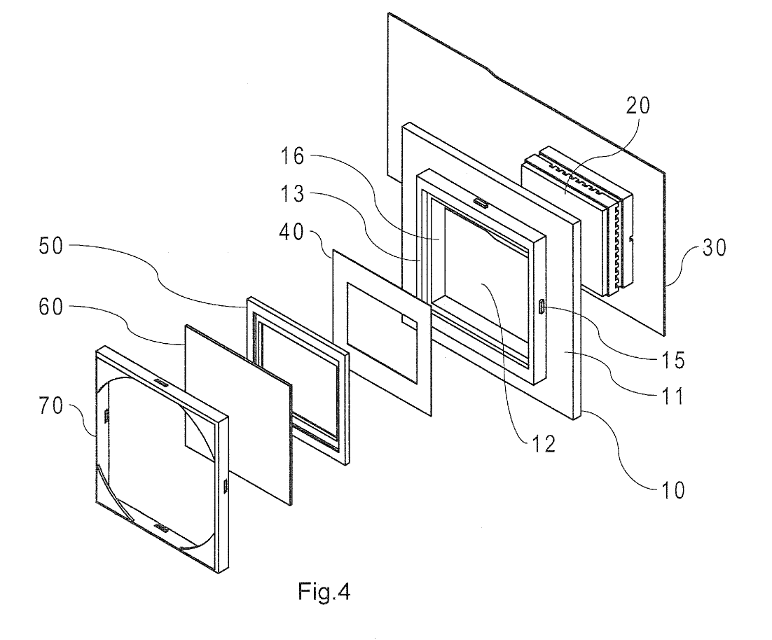

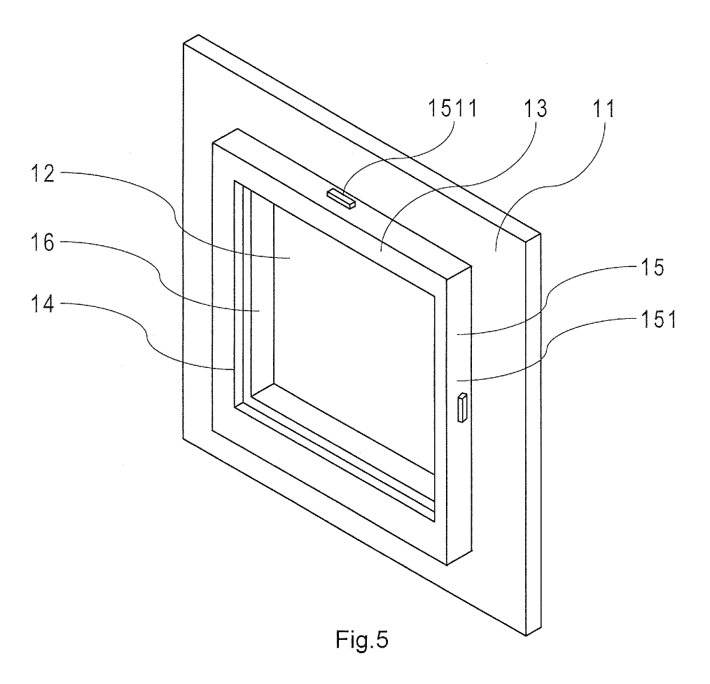

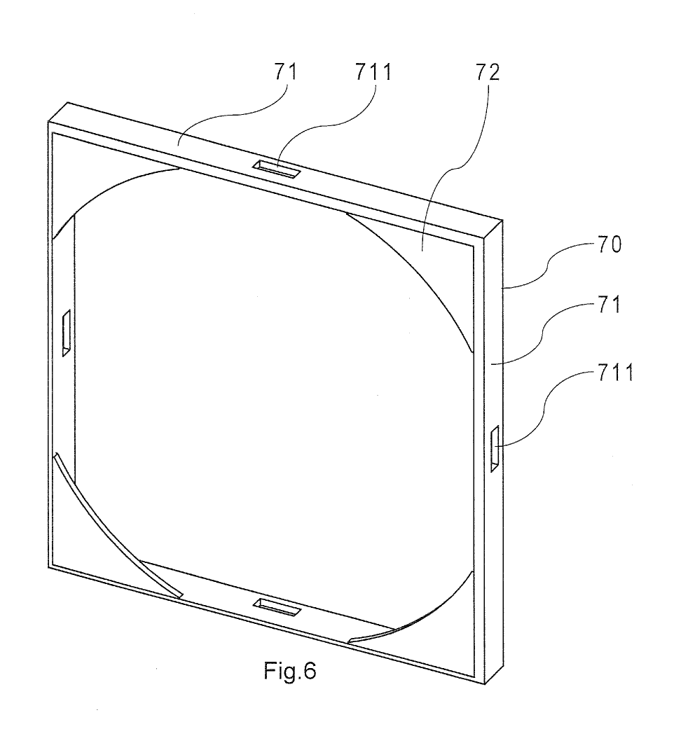

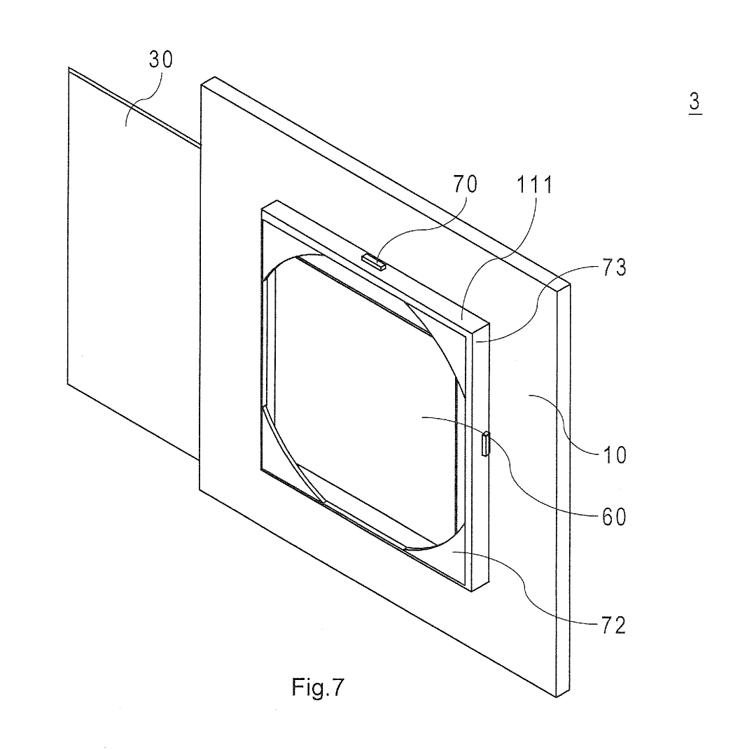

FIG. 4 is an exploded view of the first embodiment of the image sensing module of the lens module as shown in FIG. 3. FIG. 5 is a view of the socket of the image sensing module of the first embodiment. FIG. 6 is a view of the holder of the image sensing module of the first embodiment. FIG. 7 is a view of the completed assembly of the image sensing module of the first embodiment. The structure of the image sensing module of the present invention will be described in detail in the following.

The image sensing module 3 of the first embodiment comprises a socket 10, an image sensor 20 disposed in the rectangular opening 12 of the socket 10, a circuit board 30 electrically connected to the image sensor 20, a shading sheet 40, an elastic element 50, a filter 60, and a holder 70.

The socket 10 comprises a base plate 11 on which a hollowed-out rectangular opening 12 surrounded by a barrel portion 13 is disposed, wherein the barrel portion 13 comprises an inner sidewall 14 surrounding the same axis L1 as the lens barrel 2 of the lens module and an outer sidewall 15 on the other side of the inner sidewall 14. The above-mentioned inner sidewall 14 and the rectangular opening 12 form an accommodating space; therefore, when the circuit board 30 is dispensed to be fixed below the socket 10, the image sensor 20 on the circuit board 30 can be placed in the accommodating space formed by the inner sidewall 14 and the rectangular opening 12. Moreover, a plurality of rectangular supporting platforms 16 (one pair at least with each supporting platform 16 on the opposite side for example) can be further disposed on the inner sidewall 14 of the barrel portion 13, wherein the height of supporting platform 16 is smaller than that of the barrel portion 13 so that a platform can be formed with the difference of height between the barrel portion 13 and the supporting platform 16 and that the shading sheet 40, elastic element 50, and filter 60 can be placed on the supporting platform 16. Furthermore, another accommodating space can also be formed between the inner part of the supporting platform 16 and the rectangular opening 12. When the inner sidewall 14 of the barrel portion 13 is disposed with the supporting platform 16, the image sensor 20 can be placed inside the accommodating space inside the supporting platform 16 depending on the requirements of the design. Furthermore, the four sides 151 of the outer sidewall 15 of the barrel portion 13 are disposed with fastening protrusions 1511.

FIG. 6 is a view of the holder of the image sensing module of the first embodiment of the present invention. As shown in FIG. 6, the holder 70 is a rectangular hollowed-out structure with four sides 71 that are parallel to the four sides 151 of the outer sidewall 15 of the socket 10. Holes 711 are disposed respectively near the center of each of the four sides 71 of the holder 70 to be engaged by the fastening protrusions 1511 on the outer sidewall 15 of the socket 10 for the holder 70 and the socket 10 to be firmly assembled together. Moreover, flanges 72 perpendicular to the sides 71 extend respectively between the four sides 71 (i.e. four corners of the holder 70). The flanges 72 are used for pressing the shading sheet 40, the elastic element 50, and the filter 60 for placing the shading sheet 40, the elastic element 50, and the filter 60 between the flanges 72 and the supporting platform 16 of the socket 10.

In the embodiment above, the image sensor 20 can be Complementary Metal-Oxide-Semiconductor (CMOS) or Charge-Coupled Device (CCD) image sensor and the circuit board 30 can be a Flexible Printed Circuit (FPC). The elastic element 50 can be made of a kind of high polymer material to make sure the image sensor 20 is not influenced by dust or mist. Moreover, the filter 60 can be used to absorb red light, infrared light, or lights of which the wavelengths are close to that of the infrared light. Additionally, the holder 70 of the present invention can be made of metal and formed by stamping or made of engineering plastics and formed by injection molding, which is not limited in the present invention.

As shown in FIG. 4, the shading sheet 40, the elastic element 50, and the filter 60 are placed sequentially on the supporting platform 16, and the holder 70 is used to fasten these components to the socket 10 and fixed between the supporting platform 16 and the flanges 72 of the holder 70. The image sensor 20 is first fixed on the circuit board 30 by employing surface adhering technique, and then the circuit board 30 is dispensed to be fixed behind the socket 10. Thus, the image sensor 20 can be placed inside the supporting platform 16 and be assembled into the image sensing module 3 as shown in FIG. 7. The image sensing module 3 is further fixed to the shoulder 6 as shown in FIG. 3 with lock-fasteners such as the screws (omitted in the figure) for the image sensing module 3 to be placed in the second accommodating space 8.

Apparently, due to the suitable design of the holder 70, the total thickness is approximately equivalent to the depth of the side 71; and the width of the side 71 of the holder 70 can be designed as slightly smaller than the width of the outer sidewall 15 of the socket 10. Additionally, as the image sensor 20 is placed in the accommodating space inside the supporting platform 16 of the socket 10, the total thickness of the image sensing module is roughly the sum of the thickness of the socket 10 and that of the circuit board 30, and the thickness of the image sensing module 3 can be effectively reduced, which allows the lens to be thinner. Furthermore, the holder is buckled with the socket 10 through lock-fasteners, and thus the lens module can be repeatedly re-assembled and more easily assembled, and the yield of assembly can also be raised.

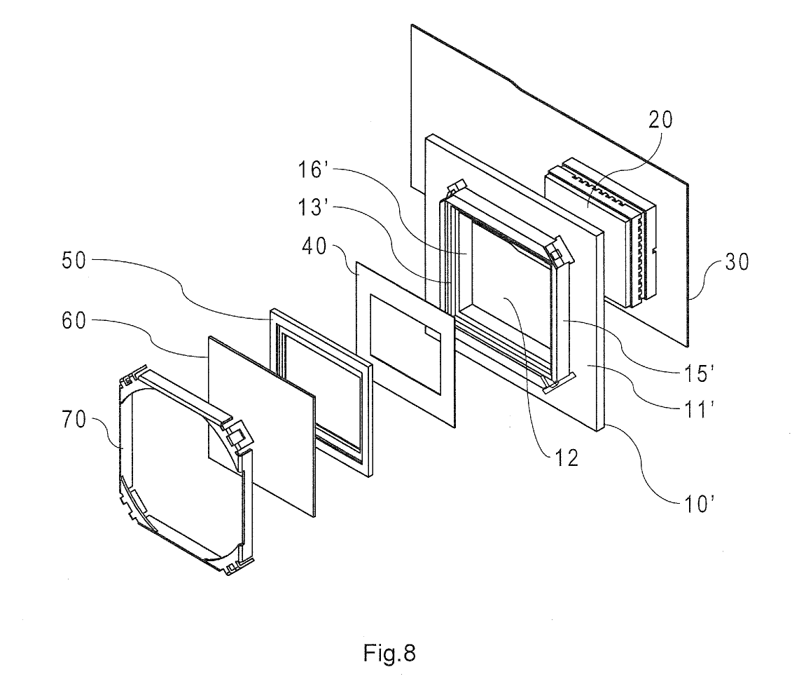

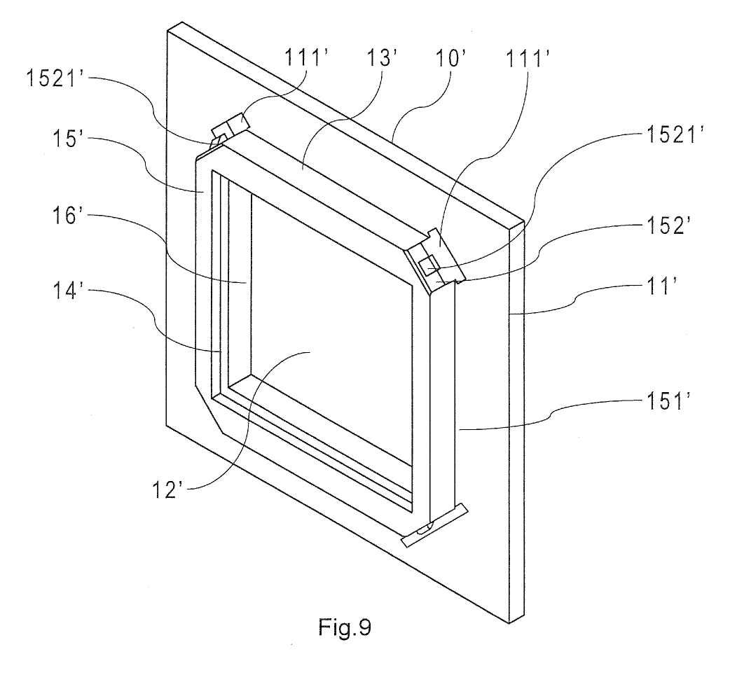

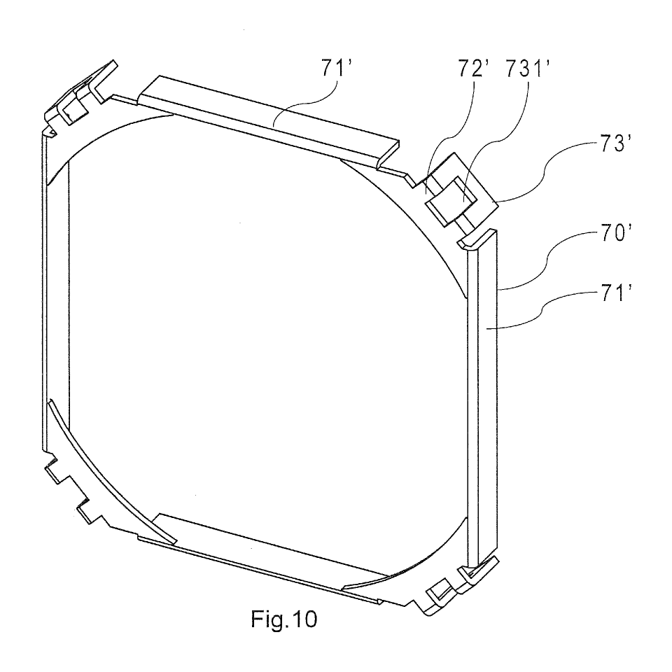

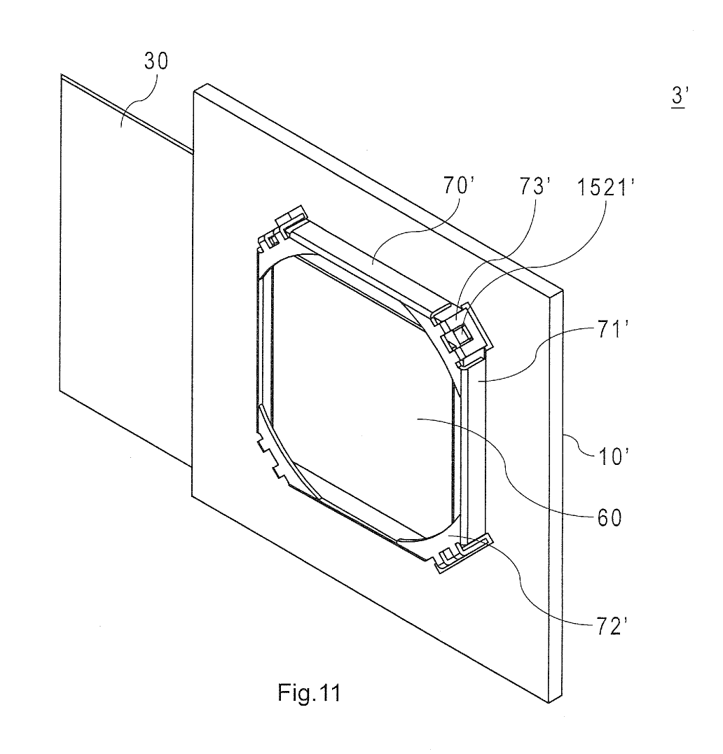

Referring then to FIG. 8, which is an exploded view of the second embodiment of image sensing module of the lens module as shown in FIG. 3. FIG. 9 is a view of the socket of the image sensing module of the second embodiment. FIG. 10 is a view of the holder of the image sensing module of the second embodiment. FIG. 11 is a view of the completed assembly of the image sensing module of the second embodiment.

The image sensing module 3′ of the second embodiment, similar to the image sensing module 3 of the first embodiment, includes a socket 10′, an image sensor 20 disposed in the rectangular opening 12′ of the socket 10, a circuit board 30 electrically connected to the image sensor 20, a shading sheet 40, an elastic element 50, a filter 60, and a holder 70′.

Referring to FIG. 9, the socket 10′ of the image sensing module 3′ of the second embodiment, being similar to the socket 10 of the first embodiment, comprises a base plate 11′, on which is disposed with a rectangular hollowed-out opening 12′ formed by the surrounding of the barrel portion 13′, wherein the barrel portion 13′ consists of an inner sidewall 14′ surrounding the same axis as the lens barrel 2 of the lens module and an outer sidewall 15′ on the other side of the inner sidewall 14′. The difference between the second embodiment and the first embodiment lies in that the outer sidewall 15′ of the barrel portion 13′ of the image sensing module 3′ of the second embodiment is octagonal-shaped and includes four long sides 151′ and four short bevels 152′ connecting to the four long sides 151′, wherein a fastening protrusion 1521′ is disposed on each of the four short bevels 152′. At the position on the base 11′ of the socket 10 opposite to the aforementioned fastening protrusions 1521′, i.e. the projected position of the fastening protrusions 1521′ on the base 11′, a through hole 111′ is disposed to allow the holder 70′ to buckle into. Moreover, a plurality of rectangular supporting platforms 16′ (one pair at least with each supporting platform on the opposite side for example) can be further placed on the inner sidewall 14′ of the barrel portion 13′ in the present embodiment, wherein the height of the supporting platform 16′ is smaller than that of the barrel portion 13′ so that a platform can be formed due to the difference of height between the barrel portion 13′ and the supporting platform 16 and the shading sheet 40, elastic element 50, and filter 60 can thus be placed on the supporting platform 16′. Meantime, an accommodation space can also be formed by the inner part of the supporting platform 16′ and the rectangular opening 12′. Depending on the requirement of the design, when the inner sidewall 14′ of the barrel portion 13′ is disposed with a supporting platform 16′, the image sensor 20 will be placed inside the accommodating space inside the supporting platform 16′.

Referring to FIG. 10, the holder 70′ is an hollowed-out octagonal-shaped structure to correspond with the design of the outer sidewall 15′ of the barrel portion 13′ and comprises four sides 71′. The four sides 71′ are parallel to the long side 151′ of the outer sidewall 15′ of the socket 10′ and connect among one another through the first flange 72′ perpendicular to and extending from the sides 71′. The first flange 72′ is one bevel of the octagonal structure and is used to press the shading sheet 40, the elastic element 50, and the filter 60 for the shading sheet 40, the elastic element 50, and the filter 60 to be placed between the first flange 72′ and the supporting platform 16′ of the socket 10′. A second flange 73′ parallel to the short bevel 152′ of the outer sidewall 15′ extends from the middle of the first flange 72′, and each of the second flanges 73′ has a hole 731′. The second flanges 73′ can enter the first through hole 111′ of the socket 10′, and the fastening protrusions 1521′ of the socket 10′ can engage with the hole 731′ on the second flange 73′, allowing the holder 70′ and the socket 10′ to be firmly assembled.

The image sensor 20, the elastic element 50, the filter 60, and the holder 70′ of the second embodiment are made of the same material in the same method as those of the first embodiment and thus the manufacturing method is not described in detail. Similarly, the shading sheet 40, the elastic element 50, and the filter 60 are sequentially placed on the supporting platform 16′ and buckled into the socket 10′ via the holder 70′ for being fixed between the supporting platform 16′ and the first flange 72′ of the holder 70′. The image sensing module 3′ is assembled as shown in FIG. 11, wherein the image sensor 20 is first fixed on the circuit board 30 by employing surface adhering technique, and then the circuit board 30 is dispensed to be fixed behind the socket 10′. The image sensing module 3′ is further fixed on the shoulder 6 as shown in FIG. 3 with lock-fasteners such as the screws (omitted in the figure) to be placed in the second accommodating space 8. As the present embodiment differs from the first embodiment only in changes of the design of the barrel portion 13′ and of the holder 70′, the effects achieved by the present embodiment is the same as those achieved by the first embodiment.

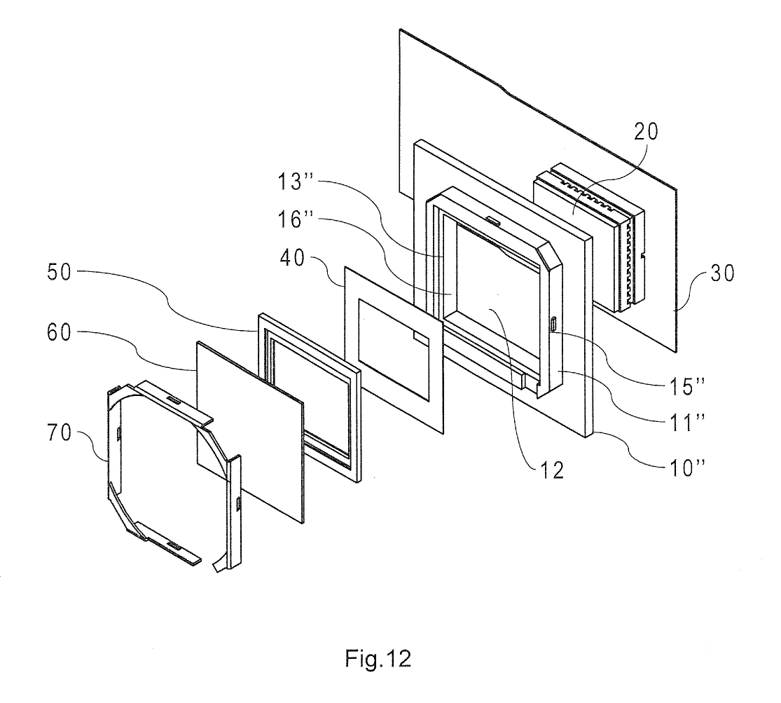

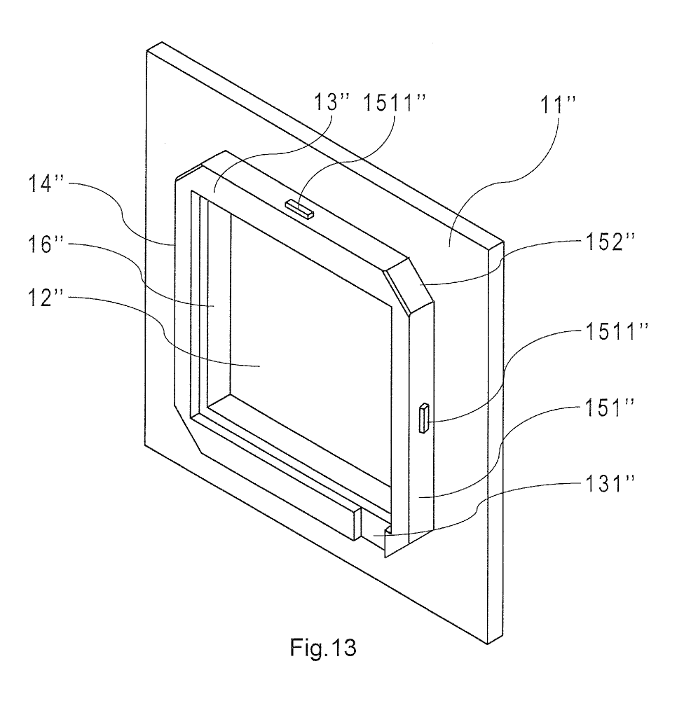

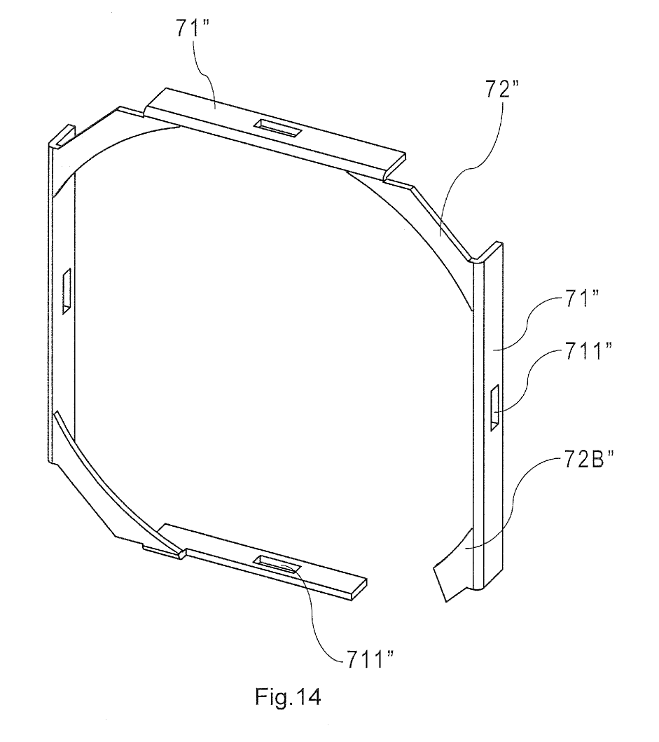

Furthermore, the design of the image sensing module of the lens module in FIG. 3 can be the same as the one in FIG. 12. The socket and the holder of the image sensing module in the third embodiment can be designed as such shown in FIG. 13 and FIG. 14.

The image sensing module 3″ of the third embodiment is similar to the image sensing module 3′ of the second embodiment and includes a socket 10″, an image sensor 20 placed in the rectangular opening 12″ of the socket 10′, a circuit board 30 electrically connected to the image sensor 20, a shading sheet 40, an elastic element 50, a filter 60, and a holder 70″.

The socket 10″ of the image sensing module 3″ of the third embodiment differs from the socket 10′ of the second embodiment in that it includes a base plate 11″ on which a rectangular opening 12″ is formed by the surrounding of the octagonal barrel portion 13″ with four corners being cut out, wherein the barrel portion 13″ is formed by an inner sidewall 14″ surrounding the same axis L1 as the lens barrel 2 of the lens module and an outer sidewall 15″ on the other side of the inner sidewall 14″. Therefore, the barrel portion 13″ of the image sensing module 3″ of the third embodiment includes four long sides 151″ and three short bevels 152″ connecting to the long sides 151″. Moreover, the fastening protrusions 1511″ are disposed on the four long sides 151″ of the barrel portion 13″ as shown in FIG. 13. Additionally, a plurality of rectangular supporting platforms 16″ (one pair at least with each of the supporting platforms 16″ on the opposite side for example) can be further placed on the inner sidewall 14″ of the barrel portion 13″ in the present embodiment, wherein the height of the supporting platform 16″ is smaller than that of the barrel portion 13″, and thus the shading sheet 40, the elastic element 50, and filter 60 can be placed on the supporting platform 16″ formed by the difference in height between the barrel portion 13″ and the supporting platform 16″. Furthermore, the inner part of the supporting platforms 16″ and the rectangular opening 12″ can also form an accommodating space. Depending on the requirement of the design, when the inner sidewall 14″ of the barrel portion 13″ is disposed with the supporting platform 16″, the image sensor 20 will be placed in the accommodating space of the inner side of the supporting platform 16″.

Referring then to FIG. 14, the holder 70″ is a hollowed-out octagonal structure with opening, the four sides 71″ of which are parallel to the long sides 151″ of the outer sidewall 15″ of the socket 10″ but one side 71B″ of which is shorter than the other three sides 71A″ due to the opening. The sides 71A″ are connected among each other through the flange 72″ perpendicular to and extending from the side 71″, and only one side of the shorter side 71B″ is disposed with the flange 72″ and the other side is a free end or open end. Therefore, the end of one side 71C″ among the three long sides 71A″ is not connected to the shorter side 71B″, and a short flange 72B″ extends from the open end of the side 71C″. Each of the above four sides 71″ has a hole 711″ which is used for being engaged by the fastening protrusion 1511″ of the socket 10″ for the holder 70″ and the socket 10″ to be firmly assembled. When the holder 70″ is assembled with the socket 10″, the above four flanges 72″, 72B″ can be used to press the shading sheet 40, the elastic element 50, and the filter 60 for the shading sheet 40, the elastic element 50, and the filter 60 to be placed between the flanges 72″, 72B″ and the supporting platform 16″ of the socket 10″.

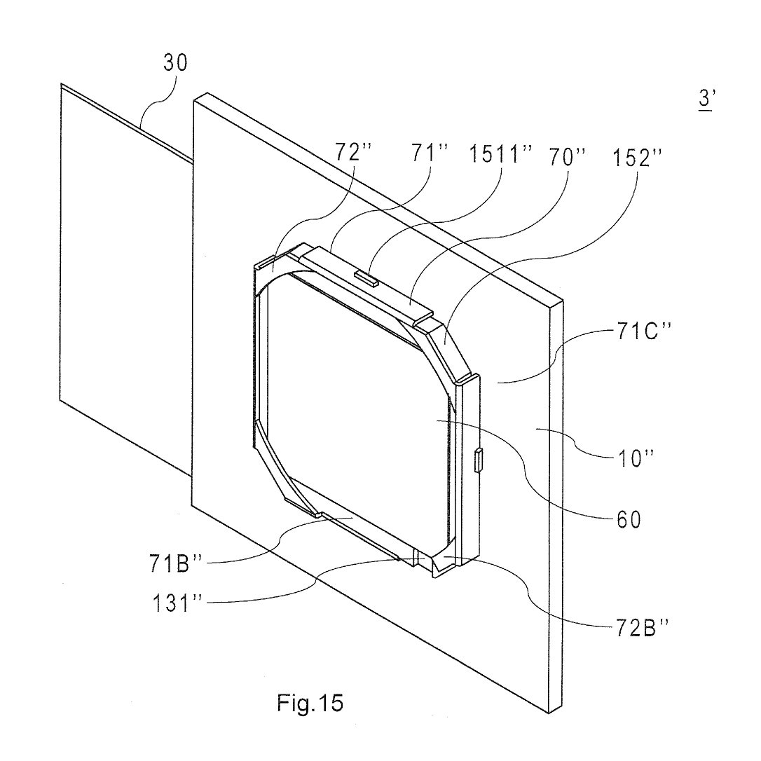

The image sensor 20, the elastic element 50, the filter 60, and the holder 70″ of the third embodiment are the same as those of the first or the second embodiment, being made of the same material and with the same manufacturing method. Similarly, the shading sheet 40, the elastic element 50, and the filter 60 are sequentially placed on the supporting platform 16″ and buckled to the socket 10″ by using the holder 70″ for the shading sheet 40, the elastic element 50, and the filter 60 to be fixed between the supporting platform 16″ and the flanges 72″ of the holder 70″. The above structure can be further assembled with the image sensor 20 and the circuit board 30 to form the image sensing module 3″ as shown in FIG. 15. Moreover, the image sensing module 3″ can be further fixed on the shoulder 6 in FIG. 3 by using lock-fasteners such as screws to be placed in the second accommodating space 8. As the present embodiment differs from the first and the second embodiments only in changes of the design of the barrel portion and of the holder, the effects achieved by the present embodiment is the same as those achieved by the first embodiment.

Furthermore, a recess can be further formed on one side of the octagonal barrel portion 13″ in the third embodiment. As FIG. 13 shows, a recess 131″ is formed on one side of the octagonal barrel portion 13″, and the side on which the recess 131″ is located is parallel to the shorter side 71B″ of the holder 70″. Thus when the holder 70″ is fixed on the octagonal barrel portion 13″, the recess 131″ will be exposed. The purpose for designing the recess 131″ is to provide a channel through which the control lines of the image sensor 20 can pass, as shown in FIG. 14.

In addition to the three embodiments described above, the image sensing module of the present invention can also one which includes the aforementioned image sensing module but excludes the shading sheet 40, namely, an image sensing module that includes only a socket 10, 10′, 10″, an image sensor 20, a circuit board 30, an elastic element 50, a filter 60, and one holder 70, 70′, 70″, or an image sensing module that includes only a socket 10, 10′, 10″, an image sensor 20, a circuit board 30, a filter 60, and one holder 70, 70′, 70″. Moreover, in the image sensing module of the present invention, the fastening protrusions can also be disposed on the holders and the holes can be disposed on the socket, and the holder and the socket can still be firmly assembled. The holder of the image sensing module of the present invention can also be designed as hollowed-out structure in other forms, for example, in the form of the holder in FIG. 10 and with an opening like the one shown in FIG. 14.

While the invention has been described by way of examples and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. An image sensing module, comprising a circuit board, an image sensor, a filter, and a socket, the characteristic of said image sensing module in that:
said filter is fixed on said socket by a holder.

2. The image sensing module according to claim 1, wherein said holder has a plurality of holes and said socket has a plurality of fastening protrusions, said plurality of holes and said plurality of fastening protrusions being able to be engaged with one another.

3. The image sensing module according to claim 2, wherein said holder has a plurality of flanges for pressing said filter.

4. The image sensing module according to claim 3, wherein said holder is an octagonal hollowed-out structure and has four sides and four bevels, said plurality of flanges being disposed on at least two of said four bevels.

5. The image sensing module according to claim 3, wherein said holder is an octagonal hollowed-out structure with opening and has four sides and three bevels, said plurality of flanges being disposed on at least two of said three bevels.

6. The image sensing module according to claim 3, wherein said holder is an octagonal hollowed-out structure with opening and has four sides and three bevels, and said plurality of flanges being disposed on at least two of said three bevels.

7. The image sensing module according to claim 3, wherein said holder is an octagonal hollowed-out structure with opening and has four sides and three bevels, said plurality of flanges being disposed on at least two of said four sides.

8. The image sensing module according to claim 3, wherein said holder is a rectangular hollowed-out structure, said plurality of flanges being disposed on at least two of said fours sides of said rectangular hollowed-out structure.

9. The image sensing module according to claim 1, wherein said socket has a plurality of fastening protrusions and said holder has a plurality of holes, said plurality of fastening protrusions and said plurality of holes being able to be engaged with one another.

10. The image sensing module according to claim 9, wherein said holder has a plurality of flanges for pressing said filter.

11. The image sensing module according to claim 10, wherein said holder is an octagonal hollowed-out structure having four sides and four bevels, said plurality of flanges being disposed on at least two of said four bevels.

12. The image sensing module according to claim 10, wherein said holder is an octagonal hollowed-out structure having four sides and four bevels, said plurality of flanges being disposed on at least two of said four sides.

13. The image sensing module according to claim 10, wherein said holder is an octagonal hollowed-out structure with opening and has four sides and three bevels, said plurality of flanges being disposed on at least two of said three bevels.

14. The image sensing module according to claim 10, wherein said holder is an octagonal hollowed-out structure with opening and has four sides and three bevels, said plurality of flanges being disposed on at least two of said four sides.

15. The image sensing module according to claim 10, wherein said holder is a rectangular hollowed-out structure, said plurality of flanges being disposed on at least two of said four sides of said rectangular hollowed-out structure.

16. The image sensing module according to claim 1, wherein said holder has a plurality of hooks, and a plurality of through holes are disposed in positions corresponding to said plurality of hooks on said socket for being engaged by said plurality of hooks.

17. The image sensing module according to claim 1, wherein a shading sheet is further disposed between said image sensor and said filter.

18. The image sensing module according to claim 1, wherein an elastic element is further disposed between said image sensor and said filter.

19. An image sensing module, comprising:
a socket, on which is disposed with an accommodating space, said accommodating space being formed by a barrel portion and a supporting platform disposed inside said barrel portion, said barrel portion of said socket being disposed with a plurality of fastening protrusions;
an image sensor, disposed inside said accommodating space formed by said supporting platform of said socket;
a circuit board, assembled with said socket and said image sensor;
a filter, disposed on said supporting platform of said socket; and
a holder, having a plurality of holes for being engaged by said plurality of fastening protrusions to fix said filter on said socket.

20. The image sensing module according to 19, wherein said holder has a plurality of flanges for pressing said filter.

21. The image sensing module according to claim 20, wherein said holder is an octagonal hollowed-out structure having four sides and four bevels, said plurality of flanges being disposed on at least two of said four bevels.

22. The image sensing module according to claim 20, wherein said holder is an octagonal hollowed-out structure having four sides and four bevels, said plurality of flanges being disposed on at least two of said four sides.

23. The image sensing module according to claim 20, wherein said holder is an octagonal hollowed-out structure with opening and has four sides and three bevels, said plurality of flanges being disposed on at least two of said three bevels.

24. The image sensing module according to claim 20, wherein said holder is an octagonal hollowed-out structure with opening and has four sides and three bevels, said plurality of flanges being disposed on at least two of said four sides.

25. The image sensing module according to claim 20, wherein said holder is a rectangular hollowed-out structure, said plurality of flanges being disposed on at least two of said four sides of said rectangular hollowed-out structure.

26. The image sensing module according to claim 19, wherein said holder has a plurality of hooks, and a plurality of through holes are disposed in positions corresponding to said plurality of hooks on said socket for being engaged by said plurality of hooks.

27. The image sensing module according to claim 19, wherein a shading sheet is further disposed between said supporting platform and said filter.

28. The image sensing module according to claim 19, wherein an elastic element is further disposed between said supporting platform and said filter.

29. The image sensing module according to claim 19, being further assembled with a lens group and a lens barrel to form a lens module.
